(19) United States
(12) Patent Application Publication
(10) Pub. No.: US 2005/0025938 A1
(43) Pub. Date: Feb. 3, 2005

(54) Method for covering a solid body with a surface layer and an adhesive film and a corresponding solid body

(76) Inventors: Edwin Esser, Dietzenbach (DE); Hans Wedel, Muhltal (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/469,058

(22) PCT Filed: Mar. 1, 2002
(86) PCT No.: PCT/DE02/00730

(30) Foreign Application Priority Data
Mar. 1, 2001 (DE) 101 09 991.6
Jun. 29, 2001 (DE) 101 31 296.2

(51) Int. Cl. H05B 6/00; H05H 1/26; B29C 59/14; B29C 59/16

(52) U.S. Cl. 428/192; 264/447; 264/483; 264/494; 156/272.6

(57) ABSTRACT

A method for covering a solid body with a surface layer and covering the surface layer with an adhesive film includes applying the surface layer to the solid body, increasing a surface energy on an exterior of the surface layer in at least one area on which the adhesive film is to be applied such that the molecular structures on the exterior of the surface layer in that at least one area are temporarily fragmented, and bonding the adhesive film to the exterior of the surface layer in the at least one area while the molecular structures are temporarily fragmented in the at least one area.

The invention relates to a method for providing a solid body with a surface layer and an adhesive film on the latter, the surface layer being applied first to the solid body. The invention also relates to a solid body provided with a surface layer and an adhesive film by means of such a method.

Methods intended for example for providing solid bodies of plastic directly with adhesive films which have an adhesive edge or appropriate symbols are known. Such methods are used inter alia for attaching adhesive films, for example hot embossing films, to cover screens of indicating instruments for motor vehicles. These adhesive films are usually arranged in an edge area of the cover screen and cover for example a connecting area of the cover screen with a housing frame of the indicating instrument. The indicating instruments are usually constructed in such a way that the cover screen is fitted into the frame and fastened to the latter by means of a weldable tongue-and-groove connection. The tongue is in this case formed by a ridge running in the edge area of the screen and protruding approximately perpendicularly from the surface of the screen, which runs in a corresponding groove on the housing frame. The cover screen and the frame are connected to each other in the area of the tongue-and-groove connection, for example by ultrasonic or vibratory welding. The connecting seam thereby produced often lies in the field of view of the vehicle driver, so that the adhesive film mentioned at the beginning is applied to the upper side of the cover screen to cover over the tongue-and-groove connection. For this purpose, the film is usually opaque.

It is also known to provide cover screens of indicating instruments with a scratch-resistant, glass-like coating in order to protect them from environmental effects, in particular mechanical damage. The adhesive film generally does not adhere to the coating materials that are usually used, since the coating is chemically inert.

It has therefore already been considered to apply the adhesive film to the cover screen first and subsequently provide the entire surface with the scratch-resistant coating. In this case, however, visible irregularities occur in the layer thickness of the coating, leading to impaired readability of the indicating instrument that cannot be tolerated, in particular in motor vehicles for reasons of road safety. In particular in the case of solar irradiation, reflections impairing the readability can occur.

Further solution proposals are either to replace the adhesive film with a lacquer or to apply an adhesion promoter to the glass-like coating applied to the cover screen and only apply the adhesive film after that. To avoid changing the optical characteristics of the cover screen (and consequently to avoid impaired readability of the instrument), the adhesion promoter may, however, be applied exclusively in the areas to be covered with adhesive. The last-mentioned methods are very complex and therefore entirely unsuitable for mass production in particular, as required for example by indicating instruments for motor vehicles.

The object on which the present invention is based is consequently to provide a low-cost method suitable for mass production for applying a surface layer and an adhesive film to a solid body, without the surface layer being damaged in any way. It is also intended to provide a covering for the indicating instrument which is constructed in such a way that the cover screen is scratch-resistant and the weld seam is not visible.

This object is achieved according to the invention by the surface energy of the exterior of the surface layer applied to the solid body being increased in at least one area where the adhesive film is to be applied, in such a way that the molecular structures on the exterior of the surface layer are temporarily fragmented in the aforementioned area, and by the adhesive film subsequently being bonded to the exterior of the surface layer, with the molecular structures being in the fragmented state. By increasing the surface energy of the exterior of the surface layer to the exterior of which the adhesive film is to be applied, the layer is reactively changed in such a way that the adhesive film permanently adheres on it. Adhesion promoters or other additives are not required. Moreover, no change takes place in the mechanical properties and in particular optical properties of the solid body. The method according to the invention is advantageously of low complexity and leads to a very low failure rate in mass production. It is suitable in particular for solid bodies which have to meet high requirements in terms of surface properties. It is merely required to increase the surface energy as described in the areas in which the adhesive film is to be applied. Because of the only temporary fragmentation of the molecular structures, however, a pretreatment of the entire surface layer is also possible without the surface layer or the solid body being damaged. The surface layer can, furthermore, be made to be very uniform, and the exterior of the adhesive film remains unaffected by the method according to the invention; it can, therefore, also be matt for example.

To increase the surface energy, it is conceivable to use a wide variety of processes, in particular high-energy processes. It has proven to be particularly advantageous if, to increase its surface energy, the exterior of the surface layer applied to the solid body is exposed to plasma. The plasma is a cloud of ionized gas. If this plasma is brought into contact with the surface layer, the molecular structures on the exterior of the surface layer are also temporarily changed, whereby an increase in the surface energy directly takes place. In this state of the surface layer, the adhesive film is applied, and a permanent bond is obtained.

The plasma exposure could take place for example by a low-pressure plasma treatment. However, an evacuated treatment chamber required for this purpose is comparatively complex. It is much simpler if, according to another advantageous development of the invention, the plasma is generated at atmospheric pressure. This makes it possible in particular for the method to be used in mass production.

According to another advantageous development of the invention, to increase its surface energy, the exterior of the surface layer applied to the solid body is exposed to short-wave high-energy UV radiation. It is likewise advantageous if, to increase its surface energy, the exterior of the surface layer applied to the solid body is treated in a corona process. The aforementioned irradiation (exposure to UV radiation) or a so-called gas discharge process (corona process) can preferably be used when corresponding machines and devices are already available and are to be used also for the method according to the invention.

By the method according to the invention, the surface layer can be excited for a limited period of time, during which the application of the adhesive film is possible. A time window of about 30 minutes has generally proven to be favorable and practicable.

The object mentioned above is also achieved by a solid body provided with a surface layer and an adhesive film by means of an aforementioned method, the solid body being a cover screen of an indicating instrument and the surface layer being a scratch-resistant coating. As a result, a very high optical quality of the cover screen is ensured after application of the adhesive film. What is more, the cover screen is protected to the greatest extent from mechanical damage, such as scratching for example. The cover screen produced by the method according to the invention is therefore particularly suitable for indicating instruments for which the readability has a safety relevance, which applies in particular to indicating instruments in motor vehicles.

An adhesive bond of particularly high and durable quality is advantageously obtained if, according to another development of the invention, the adhesive film is a hot embossing film.

In order to obtain a bond with the surface layer that is resistant for a particularly long time, the adhesive film advantageously has a hot-melt adhesive as the adhesive layer. The hot-melt adhesive is preferably a polyamide hot-melt adhesive. Consequently, particularly when hot embossing films are used, adhesive bonds which can be subjected to particularly high loads can be achieved. The polyamide hot-melt adhesive is melted by heating to heat-sealing temperature and thereby activated as an adhesive.

According to another advantageous development of the invention, the adhesive film is arranged in a peripheral edge area of the cover screen, whereby it can reliably cover over an outer area without changing the optical properties of the cover screen. The adhesive film preferably covers over a connecting area of the cover screen with a housing component of the indicating instrument, so that the indicating instrument has a clear form that does not hinder readability.

It is also conceivable, however, according to another advantageous development of the invention, for the adhesive film to form a graphic element of an indication of the indicating instrument. In this way it is possible inexpensively and easily for the cover screen to include elements which otherwise would be assigned for example to a dial. The graphic elements may be, inter alia, scalings, scale markings or indicating zones with explanatory symbols.

It is conceivable to use glass or any desired substantially transparent plastics as the material for the cover screen. However, particularly high transparency of the cover screen is obtained together with mechanical stability and ease of production if, according to another advantageous development of the invention, the cover screen substantially consists of PMMA (polymethyl methacrylate).

In particular in motor vehicles it is advantageous if, according to another development of the invention, the cover screen is an antireflection layer and/or an antimisting layer, so that, even under unfavorable conditions in terms of light and/or temperature and atmospheric humidity, the indicating instrument can be satisfactorily read.

The surface layer of the cover screen is scratch-resistant and at the same time can be used particularly well in the method according to the invention if it is constructed on the basis of polysiloxanes.

The invention may be configured in very different ways. It is explained in more detail below on the basis of an exemplary embodiment represented in the accompanying figures, in which in schematic representation

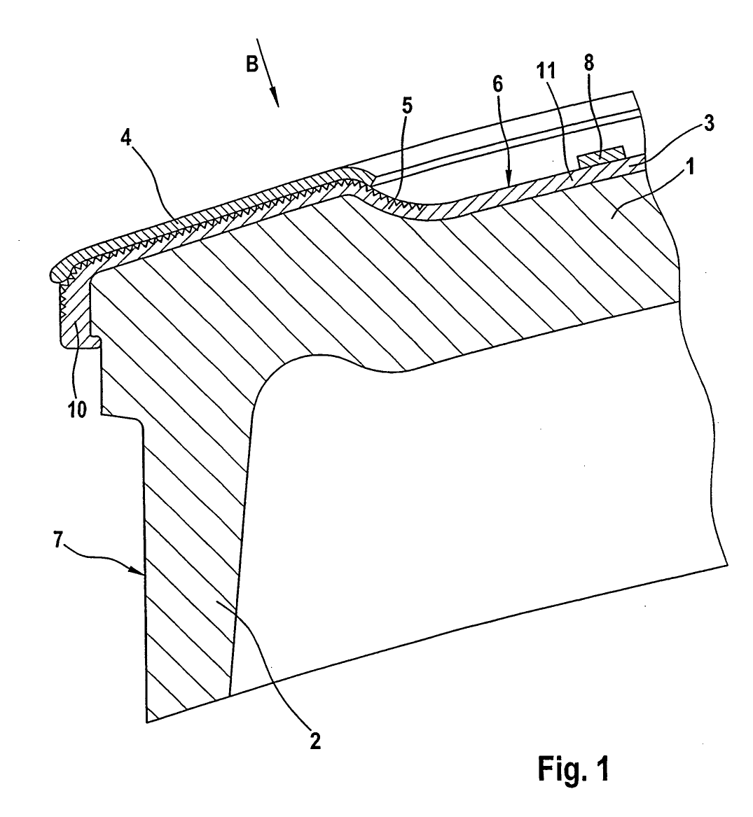

FIG. 1 shows a cover screen according to the invention in a sectioned side view and

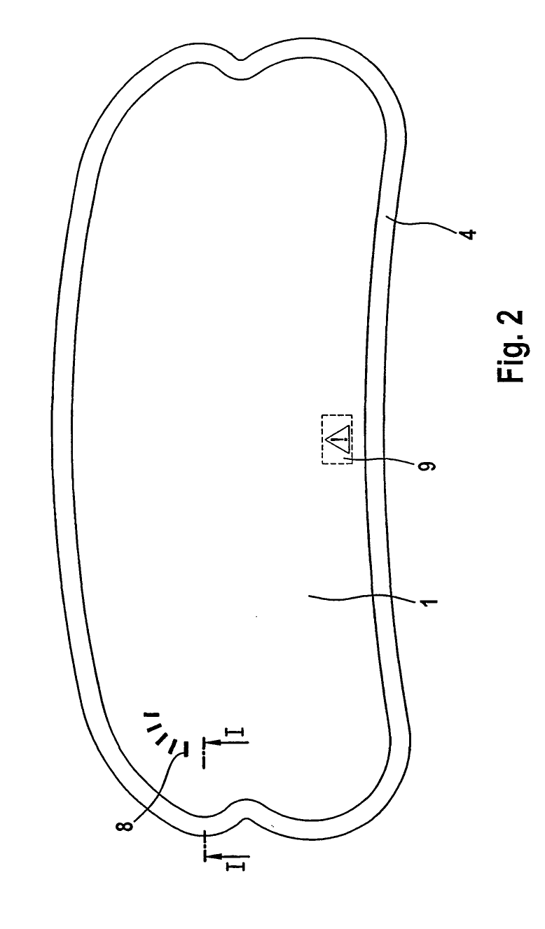

FIG. 2 shows the cover screen according to FIG. 1 in front view.

Shown in FIG. 1 is an edge area of a cover screen 1 of an indicating instrument cluster (not represented any further here) of a motor vehicle in a sectioned side view. This cover screen 1 has an elongate, approximately elliptical form (cf. FIG. 2) corresponding to the form of a housing frame of the indicating instrument cluster. On its rear side, opposite from a viewing direction B of a vehicle occupant, there is protruding approximately perpendicularly and peripherally a ridge 2 of the cover screen 1, which is fitted into a corresponding groove in the housing frame and is connected to the latter, for example welded. On the entire front side of the cover screen 1, a glass-like, scratch-resistant surface layer 3 has been applied. The surface layer 3 reaches with an edge area 10 a little way around the front side of the cover screen 1, in order to ensure complete coverage of the cover screen 1. The cover screen 1 is consequently protected from environmental influences, in particular damage by scratching, so that its surface always remains as clear as glass and the indicating instruments can be viewed well throughout the entire service life of the vehicle.

A hot embossing film 4 has been applied on the surface layer 3, peripherally in the edge area 5 of the latter, covering over a connecting area 7 which has the ridge 2 for attaching the cover screen 1 to the housing frame. The hot embossing film 4 has been adhesively attached to the exterior 6 of the surface layer 3.

Before the hot embossing film 4 is adhesively attached, the scratch-resistant surface layer 3 is exposed to plasma at atmospheric pressure on its exterior 6 in the edge area 5 indicated by a zigzag line, to increase its surface energy. The zigzag line is intended to indicate the state of the surface layer 3 with molecular structures fragmented by the increase in the surface energy, which are still present shortly after the hot embossing film 4 has been applied; thereafter, the molecular structure of the surface layer 3 then reverts to its original state again. Consequently, the energy treatment of the surface does not cause any permanent optical changes, since the surface energy is dissipated again. A difference between the edge area 5 of the surface layer 3 and the remaining areas of the surface layer 3 then no longer exists.

In such an original state again, the surface layer 3 is represented in an area 11 in which a hot embossing film has been applied in the form of a graphic element 8. It is clear from FIG. 2 that the graphic element 8 constitutes part of a scaling of an analog indicating instrument (not represented any further here), for example a tank indicator. In a central area of the cover screen 1 there is also a further graphic element 9, applied as a hot embossing film, likewise in the method described above, in the form of a warning triangle. FIG. 2 shows moreover the hot embossing film 4 covering over the connecting area of the cover screen 1 to the housing frame and also a sectional line I-I, which indicates the position of the sectional view according to FIG. 1.

1-15. (Canceled)

16. A method for providing a surface layer on a solid body and an adhesive film on the surface layer, said method comprising the steps of:
applying the surface layer to the solid body;
increasing a surface energy on an exterior of the surface layer in at least one area on which the adhesive film is to be applied such that the molecular structures on the exterior of the surface layer in that at least one area are temporarily fragmented; and
bonding the adhesive film to the exterior of the surface layer in the at least one area while the molecular structures are temporarily fragmented in the at least one area.

17. The method of claim 16, wherein said step of increasing a surface energy includes exposing the exterior of the surface layer to plasma.

18. The method of claim 17, further comprising the step of generating the plasma at atmospheric pressure.

19. The method of claim 16, wherein said step of increasing a surface energy includes exposing the exterior of the surface layer to high-energy UV radiation.

20. The method of claim 16, wherein said step of increasing a surface energy includes treating the exterior of the surface layer to a corona process.

21. An apparatus for covering an indicating instrument, comprising:
a solid body forming a cover screen for covering the indicating instrument;
a surface layer comprising a scratch-resistant coating applied to said solid body and having an exterior; and
an adhesive film bonded to at least a portion of said exterior of said surface layer, wherein said adhesive film is bonded to said at least a portion of said extension while the molecular structure of said at least a portion of said exterior of said surface layer is temporarily fragmented in response to an increase in surface energy in said at least a portion of said exterior of said surface layer.

22. The apparatus of claim 21, wherein said adhesive film is a hot-embossing film.

23. The apparatus of claim 21, wherein said adhesive film comprises an adhesive layer including hot-melt adhesive.

24. The apparatus of claim 23, wherein said hot-melt adhesive is a polyamide hot-melt adhesive.

25. The apparatus of claim 23, wherein said solid body comprises a peripheral edge area and said adhesive film is arranged on said peripheral edge area of said cover screen.

26. The apparatus of claim 25, wherein the solid body comprises a connecting area for connection of the cover screen to a housing component of the indicating instrument and said adhesive film covers the connecting area.

27. The apparatus of claim 21, wherein said adhesive film forms a graphic element of an indication for the indicating instrument.

28. The apparatus of claim 21, wherein the cover screen is made of polymethyl methacrylate (PMMA).

29. The apparatus of claim 21, wherein said surface layer comprises an antireflection layer.

30. The apparatus of claim 29, wherein said surface layer further comprises an antimisting layer.

31. The apparatus of claim 21, wherein said surface layer comprises an antimisting layer.

32. The apparatus of claim 21, wherein said surface layer is constructed using polysiloxanes.
